(19) United States
(12) Patent Application Publication
(10) Pub. No.: US 2026/0118499 A1
(43) Pub. Date: Apr. 30, 2026

(54) METHODS AND APPARATUS TO ADAPTIVELY MEASURE DISTANCES

(71) Applicant: Texas Instruments Incorporated, Dallas, TX (US)

(72) Inventors: Jayson Paul Van Marter, Richardson, TX (US); Tuan Danh Nguyen, Ås (NO); Tomas Motos, Hamar (NO)

(21) Appl. No.: 19/060,169

(22) Filed: Feb. 21, 2025

Related U.S. Application Data
(60) Provisional application No. 63/712,258, filed on Oct. 25, 2024.

(51) Int. Cl. G01S 13/84; G01S 13/82

(52) U.S. Cl. CPC G01S 13/84; G01S 13/825

(57) ABSTRACT

An example apparatus includes: channel frequency response (CFR) circuitry configured to: receive communication signals; and determine magnitudes of the communication signals; and quality metric circuitry coupled to the CFR circuitry and configured to: determine a quality metric using the magnitudes of the communication signals; select one of a first distance estimation model or a second distance estimation model using the quality metric; and estimate a distance using characteristics of the communication signals and the selected distance estimation model.

### CROSS-REFERENCE TO RELATED APPLICATION

This patent application claims the benefit of and priority to U.S. Provisional Patent Application No. 63/712,258 filed Oct. 25, 2024, which is hereby incorporated herein by reference in its entirety.

### TECHNICAL FIELD

This description relates generally to measuring distances and, more particularly, to methods and apparatus to adaptively measure distances.

### BACKGROUND

Wireless communication systems exchange data through a series of transmissions that take place in a communication environment. Devices receive information through an exchange of communication signals. Some wireless devices use characteristics of the communication signals to determine information about the communication environment. In a Bluetooth communication system, devices may use communication signal characteristics, such as time-of-flight, phase, and magnitude of a signal, to determine different conditions of the communication environment in which the Bluetooth communication system is operating.

### SUMMARY

For methods and apparatus to adaptively measure distances, an example apparatus includes channel frequency response (CFR) circuitry configured to: receive communication signals, and determine magnitudes of the communication signals, and quality metric circuitry coupled to the CFR circuitry and configured to: determine a quality metric using the magnitudes of the communication signals, select one of a first distance estimation model or a second distance estimation model using the quality metric, and estimate a distance using characteristics of the communication signals and the selected distance estimation model. Other examples are described.

For methods and apparatus to adaptively measure distances, an example method includes determining magnitudes of communication signals; determining a quality metric using the magnitudes of the communication signals, selecting one of a first distance estimation model or a second distance estimation model using the quality metric, and estimating a distance between devices using characteristics of the communication signals and the selected distance estimation model. Other examples are described.

For methods and apparatus to adaptively measure distances, an example at least one non-transitory computer readable storage medium including instructions that when executed, cause programmable circuitry to at least determine magnitudes of communication signals; determine a quality metric using the magnitudes of the communication signals, and select one of a first distance estimation model or a second distance estimation model using the quality metric to estimate a distance, and estimate a distance using characteristics of the communication signals and the selected distance estimation model. Other examples are described.

### BRIEF DESCRIPTION OF THE DRAWINGS

FIG. 1 is a block diagram of an example communication system including example adaptive distance calculator circuitry.

FIG. 2 is a block diagram of an example of the adaptive distance calculator circuitry of FIG. 1.

FIG. 3 is a flowchart representative of example machine-readable instructions or example operations that may be at least one of executed, instantiated, or performed using an example programmable circuitry implementation of the adaptive distance calculator circuitry of FIGS. 1 and 2 or more generally the communication system of FIG. 1.

FIGS. 4A and 4B are plots of example performances of example data models in line-of-sight (LOS) and non-line-of-sight (NLOS) conditions.

FIGS. 5A and 5B are plots of example error of the data models of FIGS. 4A and 4B across a range of quality metrics.

FIGS. 6A and 6B are plots of example operations of the adaptive distance calculator circuitry of FIGS. 1 and 2 for LOS and NLOS conditions.

FIG. 7 is a block diagram of an example processing platform including programmable circuitry structured to execute, instantiate, or perform the example machine-readable instructions or perform the example operations of FIG. 3 to implement the adaptive distance calculator circuitry of FIG. 2.

FIG. 8 is a block diagram of an example implementation of the programmable circuitry of FIG. 7.

FIG. 9 is a block diagram of another example implementation of the programmable circuitry of FIG. 7.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Wireless communication systems exchange data through a series of transmissions that take place in a communication environment. Devices receive information through an exchange of communication signals. Some wireless devices use characteristics of the communication signals to determine information about the communication environment. In a Bluetooth communication system, devices may use communication signal characteristics, such as time-of-flight, phase, and magnitude of a signal, to determine different conditions of the communication environment in which the Bluetooth communication system is operating.

In characterizing a communication environment, Bluetooth communication systems differentiate between line-of-sight (LOS) conditions and non-line-of-sight (NLOS) conditions. In LOS conditions, initiator and reflector devices interface directly, via an unobstructed transmission path. In NLOS conditions, the initiator and reflector devices interface indirectly, via a reflection off a surface or through an obstruction. Recently, Bluetooth specifications have begun to include channel sounding specifications. Channel sounding specifications allow Bluetooth devices to determine a distance between initiator and reflector devices using channel frequency response (CFR) measurements. CFR measurements provide characteristics of signals, such as time-of-flight, phase, and magnitude. Some Bluetooth specifications have even begun to support CFR measurements across an increasingly wide range of frequency channels, such as seventy-five channels spaced one megahertz apart.

In Bluetooth systems, devices estimate a channel impulse response (CIR) by frequency hopping across different communication channels. The device uses the CIR to determine a signal having the shortest delay offset. Such a signal often corresponds to the most direct signal path between the initiator and reflector devices. In LOS conditions, Bluetooth devices may use the characteristics of the determined signal to measure the distance between the initiator and reflector devices. For example, once the signal having the shortest delay offset is determined using the CIR, the phase of the signal and the frequency of the signal provides a time-of-flight (t). Examples and further details of measuring distances between devices are further illustrated and described in “COMBINED PHASE AND TIME-OF-FLIGHT MEASUREMENT” U.S. patent application Ser. No. 16/680,714 (U.S. Pat. No. 11,366,216) and “MULTI-NODE BASED DISTANCE MEASUREMENT” U.S. Provisional Patent Application No. 63/685,476, which is incorporated by reference in its entirety.

In LOS conditions, signaling between devices produces relatively high-quality CFR measurements responsive to a lack of obstacles or surfaces that may attenuate signals. Devices may accurately differentiate between a signal of a given signaling event and noise or reflections of other signals using the relatively high-quality CFR measurements. Once differentiated, devices implement data driven models to determine a distance between devices. In LOS conditions, data driven models, such as Inverse Fast Fourier Transform (IFFT) and Multiple Signal Classification (MUSIC) models, generalize different communication environments to produce a distance measurement. Such models are referred to as LOS models. In operation, the LOS models apply characteristics of a signal to a series of parameters that generalize the communication environment. LOS models increase the accuracy of distance measurements by generalizing communication environments for signals having high-quality CFR measurements.

However, unlike the relatively high-quality CFR measurements in LOS conditions, NLOS conditions produce relatively low-quality CFR measurements. Such a reduction in the quality of CFR measurements results from challenging multi-path components. For example, an indoor environment with a first device in a users' pocket and a second device behind a wall. In such examples, signals from the first device may form a series of different paths simultaneously. A first signal path may be formed through the user and by reflecting off of surface(s) of the indoor environment. Another signal path may be formed through the user and by propagating through the wall. At any given time, the second device may simultaneously receive signals from several non-direct signal paths. Such a combination of signals of different paths are referred to as multi-path contributions. In these NLOS conditions, Bluetooth devices can easily confuse the most direct signal path with other signal paths because of the multi-path signal contributions. Such confusion between signals of different signal paths reduces the accuracy of measurements between devices. In some examples, devices can even confuse environmental noise with multi-path signal contributions.

In NLOS conditions, the accuracy of LOS models decreases with the quality of CFR measurements. For example, in LOS conditions the LOS models have an accuracy in the centimeter or even decimeter range. However, in NLOS conditions the same LOS models have an accuracy in the multiple meter range. Although the LOS models have good performance in LOS conditions, other data models have good performance in NLOS conditions, such as support vector regression (SVR) models, neural network (NN) models, convolutional neural network (CNN) models, etc. Such data models are referred to as NLOS models. NLOS models generalize communication environments for NLOS conditions.

Unfortunately, some NLOS models, such as SVR and CNN models, require a substantial number of parameters to accurately generalize communication environments. For example, a CNN model, which is considered a deep learning model, generalizes communication environments using over ten-thousand different parameters. Such a large number of parameters in a low-power wireless device can consume substantial power, processing resources, and chip area and may suffer from significant latency. Also, SVR models need continually growing reference data sets for scalability. Such substantial needs for compute resources have limited the implementation of NLOS data models. For example, Bluetooth low energy (BLE) devices are unable to implement an extensive number of parameters responsive to relatively limited access to compute resources or data storage.

Examples described herein include methods and apparatus to adaptively measure distances using a channel quality metric to differentiate between communication conditions. In some described examples, a communication system includes initiator and reflector devices. The initiator device further includes a transmitter, a receiver, and an adaptive distance calculator. The transmitter and receiver exchange communication signals with the reflector device across a communication environment. The adaptive distance calculator determines two-way CFR measurements using the signal exchange between the initiator and reflector devices. In example operations, the adaptive distance calculator calculates a quality metric using magnitudes of signals across a plurality of two-way CFR measurements. The adaptive distance calculator determines the communication condition by comparing the quality metric to a threshold.

In example operations, the adaptive distance calculator determines the communication corresponds to NLOS conditions responsive to the quality metric being greater than the threshold. In some examples, a NLOS model determines the distance between the initiator and reflector devices responsive to the quality metric being greater than the threshold. In such example operations, the adaptive distance calculator determines the communication corresponds to LOS conditions responsive to the quality metric being less than the threshold. In some examples, a LOS model determines the distance between the initiator and reflector devices responsive to the quality metric being less than the threshold. Advantageously, determining the quality metric across a plurality of CFR measurements allows Bluetooth devices and other wireless devices to differentiate between LOS and NLOS conditions. Advantageously, using a NLOS model in NLOS conditions improves the accuracy of the distance measurement, compared to the degraded performance of LOS models in NLOS conditions. Advantageously, using a LOS model in LOS conditions improves the accuracy of the distance measurement. Advantageously, adaptively switching between different models allows devices to deploy NLOS models using fewer parameters, as compared to the number of parameters used in a model that is designed for both LOS and NLOS conditions.

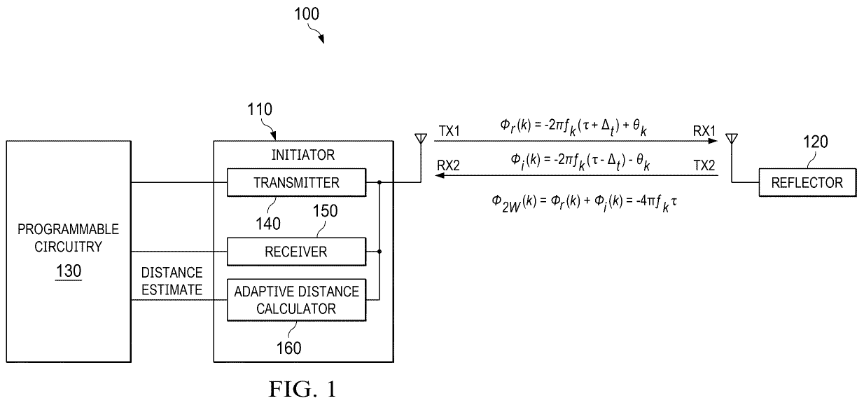

FIG. 1 is a block diagram of an example communication system 100. In the example of FIG. 1, the communication system 100 includes an initiator 110, a reflector 120, and programmable circuitry 130. The example initiator 110 of FIG. 1 includes an example transmitter circuitry 140, an example receiver circuitry 150, and an example adaptive distance calculator circuitry 160. The communication system 100 is a Bluetooth communication system. In some examples, the communication system 100 is referred to as a BLE communication system. In some examples, the communication system 100 utilizes distance measurements (also referred to as ranging) as a means of proximity detection. For example, if the initiator 110 is an entry system and the reflector 120 is a key fob (e.g., a dedicated fob, a smartphone, a wearable device, etc.), the communication system 100 allows the entry system to determine a proximity to the key fob. In another example, if the initiator 110 is a mobile device and the reflector 120 is an access point, the communication system 100 can use distance measurements to determine a location of the mobile device. In some such examples, such as in industrial uses, the proximity provided by distance measurements may be used for security, badge validation, tracking of packages and medical equipment, geo-fencing, etc. In other such examples, such as in automotive uses, ranging of the communication system 100 may be used for keyless entry, passenger identification, navigation, etc. Advantageously, the communication system 100 may utilize ranging across a wide range of BLE enabled devices.

The initiator 110 has a first input, a second input, a first output, a second output, and a third output. The first input of the initiator 110 is coupled to the programmable circuitry 130. The second input and the first output of the initiator 110 are coupled to the reflector 120. The second and third outputs of the initiator 110 are coupled to the programmable circuitry 130.

The reflector 120 has an input and an output coupled to the initiator. In some examples, the initiator 110 and the reflector 120 are coupled by antennas. In some such examples, the antennas allow the initiator 110 and the reflector 120 to form a communication channel for exchanging data.

The programmable circuitry 130 has a first input, a second input, and an output coupled to the initiator 110. In some examples, the programmable circuitry 130 is implemented on the same chip or integrated circuit as the initiator 110. In other examples, the programmable circuitry 130 is implemented on a separate chip or integrated circuit from the initiator 110, such as in a multi-chip module.

The transmitter circuitry 140 has an input and an output. The input of the transmitter circuitry 140 is coupled to the programmable circuitry 130. The output of the transmitter circuitry 140 is coupled to the reflector 120, the receiver circuitry 150, and the adaptive distance calculator circuitry 160.

The receiver circuitry 150 has an input and an output. The input of the receiver circuitry 150 is coupled to the reflector 120, the transmitter circuitry 140, and the adaptive distance calculator circuitry 160. The output of the receiver circuitry 150 is coupled to the programmable circuitry 130.

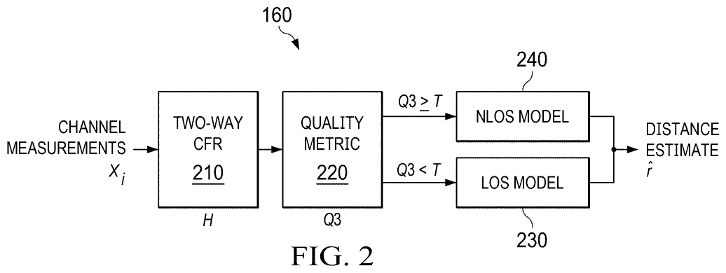

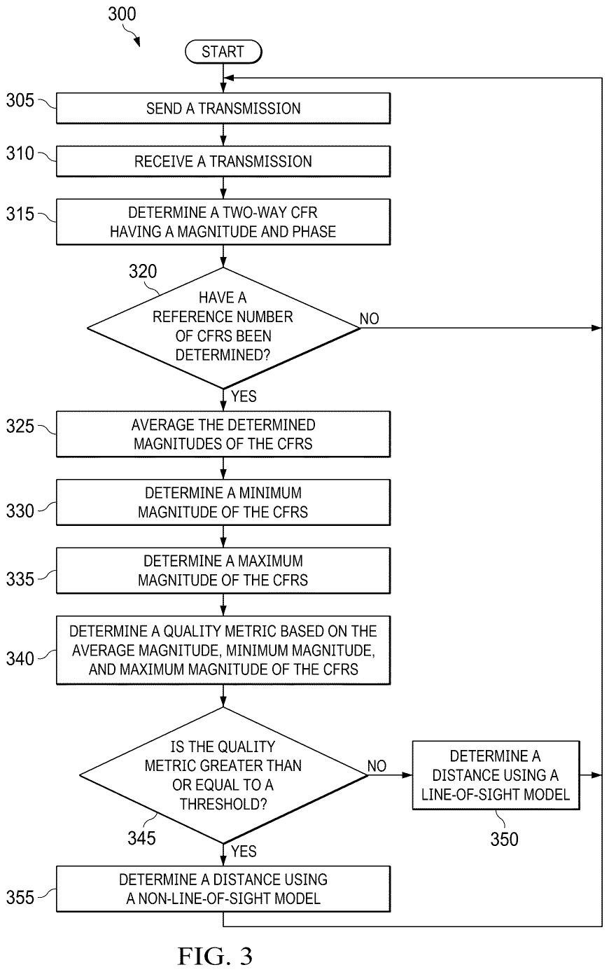

The adaptive distance calculator circuitry 160 has an input and an output. The input of the adaptive distance calculator circuitry 160 is coupled to the reflector 120, the transmitter circuitry 140, and the receiver circuitry 150. The output of the adaptive distance calculator circuitry 160 is coupled to the programmable circuitry 130. In some examples, the adaptive distance calculator circuitry 160 is coupled between the receiver circuitry 150 and the programmable circuitry 130. In some such examples, the adaptive distance calculator circuitry 160 may be implemented by the programmable circuitry 130. An example of the adaptive distance calculator circuitry 160 is further illustrated and described in connection with FIGS. 2 and 3.

In example operation, the programmable circuitry 130 configures the transmitter circuitry 140 or more generally the initiator 110 to transmit a signal at a given frequency. The transmitter circuitry 140 transmits a first signal having a first frequency (fₖ). The reflector 120 at least one of receives or reflects the first signal. During the propagation of the first signal (also referred to as a reflector signal), characteristics of the communication environment, which surrounds the communication system 100, modify a phase offset (θₖ) and time offset (Δₜ) of the first signal. Similarly, the time-of-flight (τ) of the first signal between the initiator 110 and the reflector 120 modifies the phase (φᵣ) of the first signal. In some examples, the phase of the first signal after propagating the communication environment may be represented by Equation (1).

$${ϕ}_{r} ( k ) = - 2 π f ( τ + {Δ}_{t} ) + {θ}_{k} \qquad Equation ( 1 )$$

In such example operations, the reflector 120 at least one of transmits a second signal or reflect the first signal. In some examples, the second signal (φᵢ(k)) is a reflection of the first signal (φᵣ(k)). The receiver circuitry 150 and the adaptive distance calculator circuitry 160 receive the second signal after propagating through the communication environment. Similar to the propagation of the first signal, the characteristics of the communication environment modify a phase offset (θₖ) and time offset (Δₜ) of the second signal. Also, the time-of-flight (τ) of the second signal between the initiator 110 and the reflector 120 modifies the phase (φᵢ) of the second signal. In some examples, the phase of the second signal after propagating the communication environment may be represented by Equation (2).

$${ϕ}_{i} ( k ) = - 2 π f ( τ - {Δ}_{t} ) - {θ}_{k} \qquad Equation ( 2 )$$

In some examples, combining the first and second signals provides a two-way signal (φ_{2w} (k)) representation of the signaling event. Advantageously, the communication environment proportionally affects the time offset and phase offset of the first and second signals. Advantageously, the time offset and phase offset of the first and second signals cancel leaving the two-way signal representation as shown in Equation (3). Advantageously, in two-way signaling the phase of the received signal is proportional to the time-of-flight of the first and second signals. Advantageously, the distance estimate, also referred to as a range (r), between the initiator 110 and the reflector 120 may be found using Equation (4), which uses the time-of-flight (τ) and the speed of light (c).

$${ϕ}_{2 W} ( k ) = {ϕ}_{r} ( k ) + {ϕ}_{i} ( k ) = - 4 π f τ \qquad Equation ( 3 )$$

$$r = τ \times c \qquad Equation ( 4 )$$

In some example operations, the communication system 100 hops between a plurality of communication channels having different frequencies to differentiate signals across a range of different frequencies. For example, the initiator 110 calculates a first range using two-way signaling at a first frequency and a second range using two-way signaling at a second frequency. Such hopping between communication channels of different frequencies is referred to as frequency hopping. In some examples, frequency hopping allows the initiator 110 to differentiate between signal contributions from previous signaling events.

In such example operations, the adaptive distance calculator circuitry 160 uses a plurality of two-way signaling events to determine a quality metric. The quality metric is a representation of the variation between characteristics of signals across different signaling events. In LOS conditions, a CFR calculation accurately detects a signal of a given signaling event from noise of the environment responsive to a lack of obstacles attenuating the signals. In NLOS conditions, obstacles and reflections of different signals, such as reflections of signals of previous signaling events, attenuate or saturate signals of a current signaling event. In such example conditions, changes in the attenuation or saturation of signals change over time. The adaptive distance calculator circuitry 160 detects an increase in the quality metric as variations in the CFR calculations change over time. The quality metric allows the initiator 110 to differentiate between LOS and NLOS conditions. Example operations of the adaptive distance calculator circuitry 160 are further illustrated and described in connection with FIGS. 2 and 3.

FIG. 2 is a block diagram of an example implementation of the adaptive distance calculator circuitry 160 of FIG. 1. The adaptive distance calculator circuitry 160 of FIG. 2 may be instantiated (e.g., creating an instance of, bring into being for any length of time, materialize, implement, etc.) by programmable circuitry such as a Central Processor Unit (CPU) executing first instructions. Also or alternatively, the adaptive distance calculator circuitry 160 of FIG. 2 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the adaptive distance calculator circuitry 160 of FIG. 2 may, thus, be instantiated at the same or different times. Some or all of the adaptive distance calculator circuitry 160 of FIG. 2 may be instantiated, for example, in one or more threads executing concurrently on hardware or in series on hardware. Moreover, in some examples, some or all of the adaptive distance calculator circuitry 160 of FIG. 2 may be implemented by microprocessor circuitry executing instructions or FPGA circuitry performing operations to implement one or more virtual machines or containers. The example adaptive distance calculator circuitry 160 of FIG. 2 includes example CFR circuitry 210, example quality metric circuitry 220, an example LOS distance estimation model 230, and an example NLOS distance estimation model 240.

The adaptive distance calculator circuitry 160 has an input and an output. The input of the adaptive distance calculator circuitry 160 is structured to be coupled to the reflector 120 of FIG. 1. The output of the adaptive distance calculator circuitry 160 is structured to be coupled to the programmable circuitry 130.

The CFR circuitry 210 has an input and an output. The input of the CFR circuitry 210 is coupled to the input of the adaptive distance calculator circuitry 160, which provides channel measurements. The output of the CFR circuitry 210 is coupled to the quality metric circuitry 220. In some examples, the CFR circuitry 210 is instantiated by programmable circuitry executing CFR instructions to perform operations such as those represented by the flowchart of FIG. 3.

The quality metric circuitry 220 has an input, a first output, and a second output. The input of the quality metric circuitry 220 is coupled to the CFR circuitry 210. The first output of the quality metric circuitry 220 is coupled to the LOS distance estimation model 230. The second output of the quality metric circuitry 220 is coupled to the NLOS distance estimation model 240. In some examples, the quality metric circuitry 220 is instantiated by programmable circuitry executing quality metric instructions to perform operations such as those represented by the flowchart of FIG. 3.

The LOS distance estimation model 230 has an input and an output. The input of the LOS distance estimation model 230 is coupled to the quality metric circuitry 220. The output of the LOS distance estimation model 230 is coupled to the output of the adaptive distance calculator circuitry 160 and the NLOS distance estimation model 240. In some examples, the LOS distance estimation model 230 is instantiated by programmable circuitry executing LOS model instructions to perform operations such as those represented by the flowchart of FIG. 3.

The NLOS distance estimation model 240 has an input and an output. The input of the NLOS distance estimation model 240 is coupled to the quality metric circuitry 220. The output of the NLOS distance estimation model 240 is coupled to the output of the adaptive distance calculator circuitry 160 and the LOS distance estimation model 230. In some examples, the NLOS distance estimation model 240 is instantiated by programmable circuitry executing NLOS model instructions to perform operations such as those represented by the flowchart of FIG. 3.

In some examples, the NLOS distance estimation model 240 is a feed-forward neural network. In such examples, the feed-forward neural network uses a constrained number of variables to generalize NLOS conditions. For example, the NLOS distance estimation model 240 may utilize one-thousand variables across multiple layers. Deep-learning NNs can easily scale up to tens of thousands of variables. Advantageously, limiting the number of variables of the NLOS distance estimation model 240 reduces the amount of compute resources needed to deploy distance estimation. Advantageously, implementing the NLOS distance estimation model 240 as a variable limited NN allows BLE devices to implement distance estimation for ranging between devices. Example operations of the adaptive distance calculator circuitry 160 are further illustrated and described in connection with FIG. 3.

FIG. 3 is a flowchart representative of example machine-readable instructions or example operations 300 that may be at least one of executed, instantiated, or performed using an example programmable circuitry implementation of the adaptive distance calculator circuitry 160 of FIGS. 1 and 2 or more generally the communication system 100 of FIG. 1. The example operations 300 of FIG. 3 begin at Block 305 at which the transmitter circuitry 140 of FIG. 1 sends a transmission. In example operations, as described above, the transmitter circuitry 140 begins a distance measurement by transmitting a signal (φᵣ(k)) at a given frequency. In some examples, the transmitter circuitry 140 transmits data encoded on a cosine waveform carrier as the signal to the reflector 120 of FIG. 1. During the transmission of the signal to the reflector 120, characteristics of the communication environment modify the phase offset (θₖ), the time offset (Δₜ), and the time-of-flight (τ) of the signal. In some examples, Equation (1) represents the signal as seen by the reflector 120. In some such examples, the reflector 120 determines characteristics of the received signal

$$( {x}_{i}^{R} ) .$$

The measurements of the reflector 120 include the amplitude

$$( {α}_{i}^{R} )$$

and phrase (φᵣ) of the received signal. Such a representation of the received signal is illustrated by Equation (5). In other examples, the initiator 110 determines the measurements of the received signal responsive to a reflection off of the reflector 120.

$${x}_{i}^{R} = {α}_{i}^{R} {e}^{j {ϕ}_{r}} \qquad Equation ( 5 )$$

The receiver circuitry 150 of FIG. 1 receives a transmission. (Block 310). In example operations, the reflector 120 reflects the signal from the transmitter circuitry 140. Similar to traversing from the initiator 110 to the reflector 120, the characteristics of the communication environment modify the phase offset (θₖ), the time offset (Δₜ), and the time-of-flight (τ) of the reflected signal (φᵢ(k)). In some examples, Equation (2) represents the reflected signal as seen by the initiator 110. In some such examples, the initiator 110 determines characteristics of the reflected signal

$$( {x}_{i}^{I} ) .$$

The measurements of the initiator 110 include the amplitude

$$( {α}_{i}^{I} )$$

and phase (φᵢ) of the reflected signal. Such a representation of the reflected signal is illustrated by Equation (6).

$${x}_{i}^{I} = {α}_{i}^{I} {e}^{j {ϕ}_{i}} \qquad Equation ( 6 )$$

The CFR circuitry 210 of FIG. 2 determines a two-way CFR having a magnitude and phase. (Block 315). As described above in connection with Equation (3), adding the phases of the two-way signaling allows Bluetooth devices to determine a distance from the time-of-flight of a signal. In example operation, the CFR circuitry 210 determines a magnitude and phase of the two-way signaling event by combining the received and reflected signals

$$( {x}_{i}^{I} , {x}_{i}^{R} ) .$$

In some examples, Equation (7) represents the combination of the two-way signaling.

$${x}_{i}^{I} \times {x}_{i}^{R} = H = {α}_{i}^{I} {e}^{j {ϕ}_{i}} \times {α}_{i}^{R} {e}^{j {ϕ}_{r}} = {α}_{i}^{I} {α}_{i}^{R} {e}^{j ( {ϕ}_{i} + {ϕ}_{r} )} \qquad Equation ( 7 )$$

The quality metric circuitry 220 of FIG. 2 determines if a reference number of CFRs have been determined. (Block 320). In example operations, the CFR circuitry 210 provides CFR data including magnitude and phases of the signals to the quality metric circuitry 220. In some such examples, the quality metric circuitry 220 stores the CFR data across signaling events. In some examples, the quality metric circuitry 220 stores CFR data for a plurality of antennas. For example, if the initiator 110 has seventy antennas, the quality metric circuitry 220 may store CFR data of each antenna. Alternatively, the quality metric circuitry 220 may also average the CFR data of a series. For example, if the initiator 110 has seventy antennas, the quality metric circuitry 220 may store an average of the CFR data across the antennas.

If the quality metric circuitry 220 determines that the reference number of CFRs have not been determined (e.g., Block 320 returns a result of NO), control proceeds to return to Block 305. In some examples, the initiator 110 is structured to frequency hop between transmissions. In such examples, the transmitter circuitry 140 changes to (e.g., hops) a different channel at a different frequency. Such frequency hopping allows the receiver circuitry 150 and the adaptive distance calculator circuitry 160 to differentiate between different transmission events.

If the quality metric circuitry 220 determines that the reference number of CFRs have been determined (e.g., Block 320 returns a result of YES), the quality metric circuitry 220 averages the determined magnitudes of the CFRs. (Block 325). In example operations, after receiving the magnitudes of a plurality of signaling events, the quality metric circuitry 220 averages the magnitudes to determine an average magnitude (u). For example, if the quality metric circuitry 220 stores data of eight signaling events, the quality metric circuitry 220 determines an average of the magnitudes of the CFR data

$$( \vert {x}_{i}^{I} \vert , \vert {x}_{i}^{R} \vert ) .$$

In some examples, the quality metric circuitry 220 may determine an average magnitude of the received signals and an average magnitude of the reflected signals.

The quality metric circuitry 220 determines a minimum magnitude of the CFRs. (Block 330). In example operations, the quality metric circuitry 220 determines the minimum magnitude of the stored CFR data. For example, if the quality metric circuitry 220 stores data of eight signaling events, the quality metric circuitry 220 determines the minimum magnitude of the CFR data (min(|xᵢ|)). In some examples, the quality metric circuitry 220 may determine the minimum magnitude of the received signals and the minimum magnitude of the reflected signals.

The quality metric circuitry 220 determines a maximum magnitude of the CFRs. (Block 335). In example operations, the quality metric circuitry 220 determines the maximum magnitude of the stored CFR data. For example, if the quality metric circuitry 220 stores data of eight signaling events, the quality metric circuitry 220 determines the maximum magnitude of the CFR data (max(|xᵢ|)). In some examples, the quality metric circuitry 220 may determine the maximum magnitude of the received signals and the maximum magnitude of the reflected signals.

The quality metric circuitry 220 determines a quality metric based on the average magnitude, minimum magnitude, and maximum magnitude of the CFRS. (Block 340). In example operations, the quality metric circuitry 220 determines a quality metric (Q3) by normalizing the range of magnitudes by the mean. The quality metric circuitry 220 may use Equation (8) to determine the quality metric. In some examples, the quality metric circuitry 220 may determine a quality metric of the received signals and a quality metric of the reflected signals. In such examples, the quality metric circuitry 220 may average the determined quality metrics to produce a quality metric of reflected and received signals.

$$Q 3 = \frac{1}{μ} [ max ( \vert {x}_{i} \vert ) - min ( \vert {x}_{i} \vert ) ] \qquad Equation ( 8 )$$

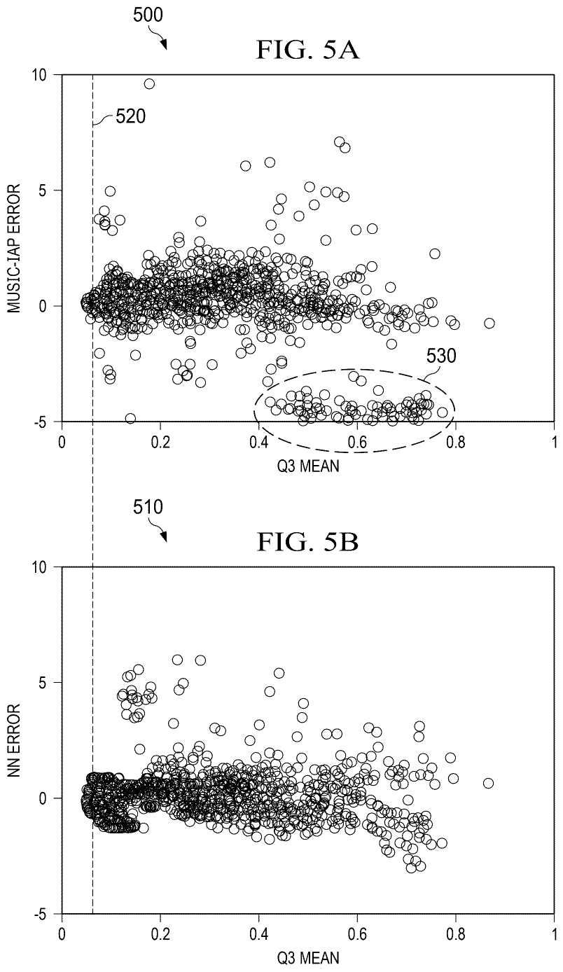

The quality metric circuitry 220 determines if the quality metric is greater than or equal to a threshold. (Block 345). In example operations, the quality metric circuitry 220 compares the determined quality metric to a threshold quality metric. The threshold quality metric represents a transition between using the distance estimation models 230, 240. An example of the threshold quality metric is illustrated and described in connection with FIGS. 5A and 5B. In such example operations, the threshold quality metric depends on the distance estimation models being implemented by the distance estimation models 230, 240. In some such examples, the threshold quality metric can be determined by determining an error in the distance calculation across a wide range of different communication environments for both of the distance estimation models 230, 240.

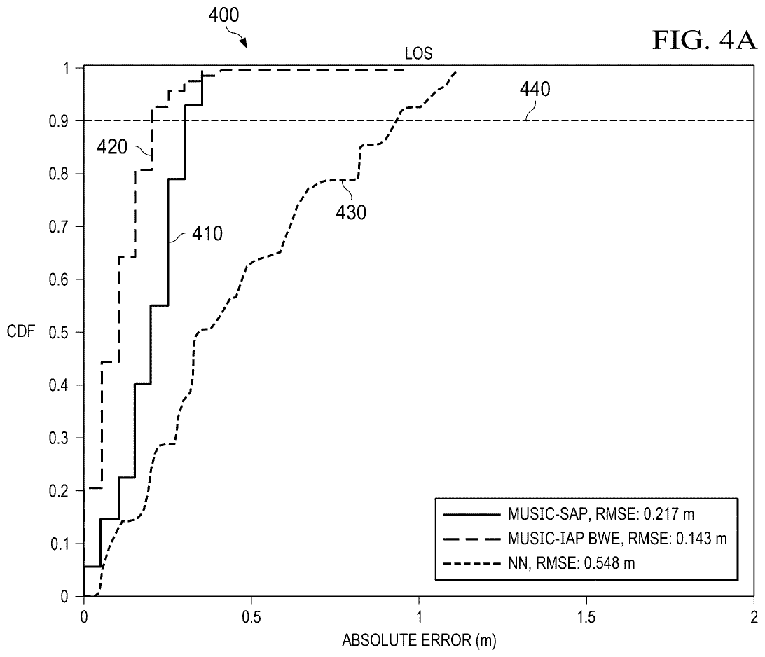

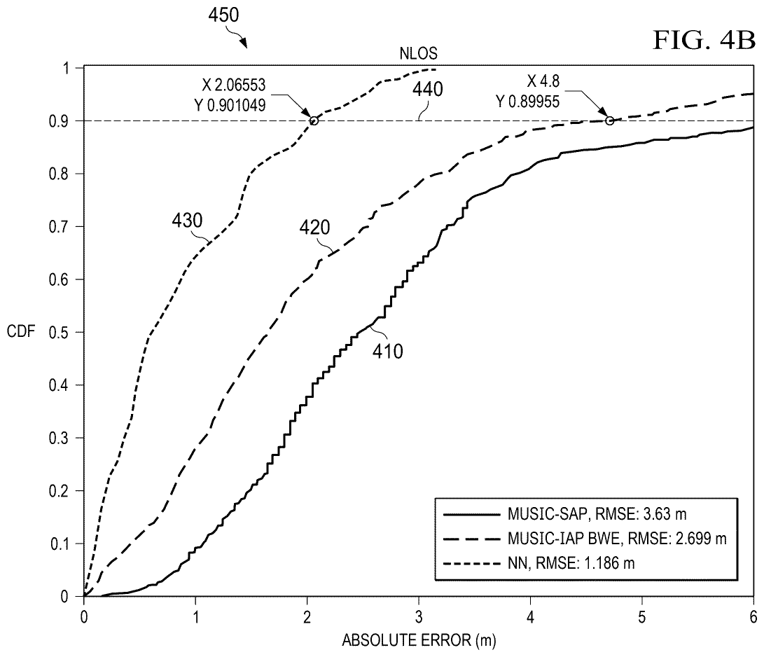

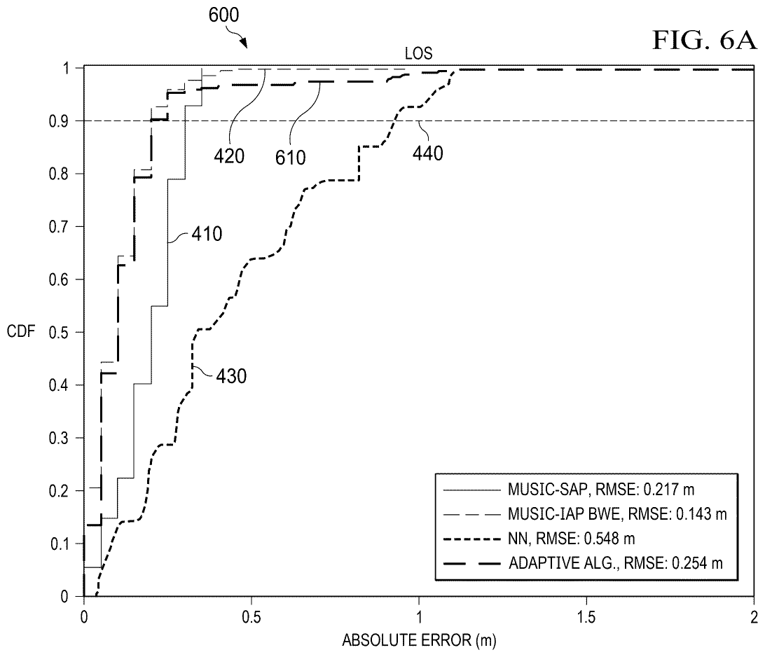

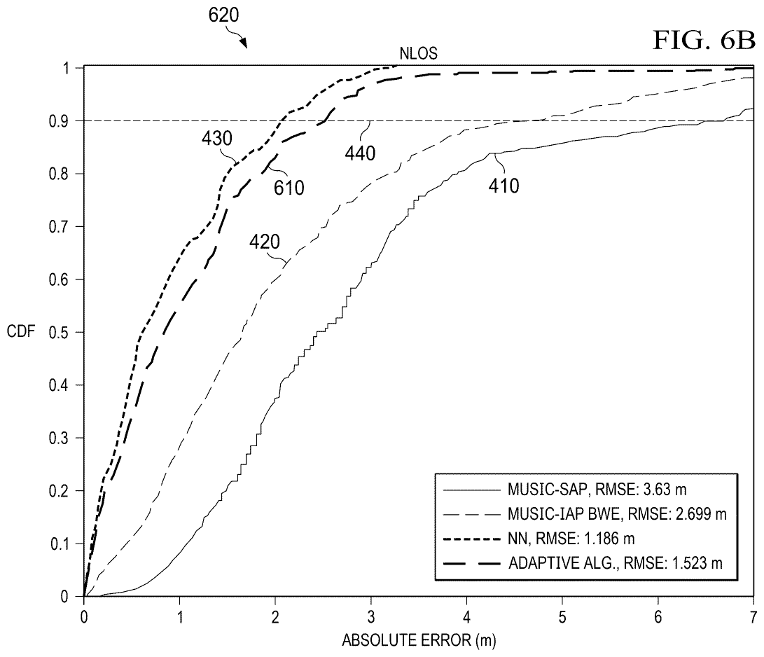

If the quality metric circuitry 220 determines that the quality metric is not greater than or equal to the threshold (e.g., Block 345 returns a result of NO), the LOS distance estimation model 230 of FIG. 2 determines a distance using a line-of-sight model. (Block 350). In example operations, the quality metric circuitry 220 provides the CFR data to the LOS distance estimation model 230 responsive to the determined quality metric being less than the threshold quality metric. In such example operations, the LOS distance estimation model 230 is a model-based algorithm that has a relatively high accuracy and generalizability in LOS conditions. For example, MUSIC and IFFT models have relatively high accuracy in situations in which the multi-path components are attenuated, such as cases in which a direct path is available between the initiator 110 and the reflector 120. However, as the main signal path is attenuated by obstacles, the accuracy of the MUSIC and IFFT models decrease. Such performance of examples of the LOS distance estimation model 230 are further illustrated and described in connection with FIGS. 4A, 4B, 6A, and 6B. Advantageously, the determined quality metric decreases as less obstacles attenuate the amplitude of the signaling. In such example operations, the LOS distance estimation model 230 determines the distance between the initiator 110 and the reflector 120 using the CFR data.

If the quality metric circuitry 220 determines that the quality metric is greater than or equal to the threshold (e.g., Block 345 returns a result of YES), the NLOS distance estimation model 240 of FIG. 2 determines a distance using a non-line-of-sight model. (Block 355). In example operations, the quality metric circuitry 220 provides the CFR data to the NLOS distance estimation model 240 responsive to the determined quality metric being greater than or equal to the threshold quality metric. In such example operations, the NLOS distance estimation model 240 is a model-based algorithm that has a relatively high accuracy and generalizability in NLOS conditions. For example, SVR, CNN, and NN models have relatively high accuracy in situations in which the multi-path components are relatively large in comparison to the main signal path. Such as cases in which a direct path is not available between the initiator 110 and the reflector 120. However, as the amplitude of the main signal path increases, the accuracy of the SVR and NN models begin to decrease. Such performance of examples of the NLOS distance estimation model 240 are further illustrated and described in connection with FIGS. 4A, 4B, 6A, and 6B. Advantageously, the determined quality metric increases as more obstacles attenuate the amplitude of the signaling. In such example operations, the NLOS distance estimation model 240 determines the distance between the initiator 110 and the reflector 120 using the CFR data.

Control proceeds to return to Block 305. Initiator 110 may be configured to perform the operations of FIG. 3 at regular intervals during communication or in response to a trigger event, in order to optimize the estimates of distance. For example, the initiator 110 may generate several estimates of distance using a LOS model and trigger the operations of FIG. 3 when the variance of the estimates exceeds a threshold level. As another example, the initiator 110 may generate several estimates of distance using an NLOS model and trigger the operations of FIG. 3 when the variance of the estimates is less than a threshold level. Example methods are described with reference to the flowchart illustrated in FIG. 3. However, many other methods of implementing the adaptive distance calculator circuitry 160 of FIGS. 1 and 2 or more generally the communication system 100 of FIG. 1 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 4A is a plot 400 of example performances of a first example data model 410, a second example data model 420, and a third example data model 430 under example LOS conditions. In the example of FIGS. 4A and 4B, the data models 410, 420 represent an absolute error of example implementations of the MUSIC data model as a cumulative distribution function (CDF). In the example of FIGS. 4A and 4B, the data model 430 represents an absolute error of example implementations of a NN data model as a CDF.

In example operation of the communication system 100, the distance measurement between the CDF of the data models 410, 420, 430 compound as the absolute error increases. At an example threshold CDR 440, which corresponds to a ninety percent accuracy, the data model 410 accurately determines a distance with an error of approximately twenty-one centimeters. At the threshold CDR 440, the data model 420 accurately determines a distance with an error of approximately fourteen centimeters. However, at the threshold CDR 440, the data model 430 accurately determines a distance with an error of approximately fifty-five centimeters. Advantageously, the data models 410, 420 have a relatively high accuracy in comparison to the data model 430 in LOS conditions.

FIG. 4B is a plot 450 of example performances of the data models 410, 420, 430 under example NLOS conditions. In example operation of the communication system 100, the distance measurement between the CDF of the data models 410, 420, 430 compound as the absolute error increases. At the example threshold CDR 440, which corresponds to a ninety percent accuracy, the data model 410 accurately determines a distance with an error of approximately three-hundred and sixty centimeters. At the threshold CDR 440, the data model 420 accurately determines a distance with an error of approximately two-hundred and seventy centimeters. However, at the threshold CDR 440, the data model 430 accurately determines a distance with an error of approximately one-hundred and nineteen centimeters. Advantageously, the data model 430 has a relatively high accuracy in comparison to the data models 410, 420 in NLOS conditions.

FIG. 5A is a plot 500 of an example distance error across a range of averages of determined quality metric (Q3) for an example implementation of a MUSIC data model. In some examples, the quality metric circuitry 220 of FIG. 2 determines the average quality metric by averaging determined quality metrics across all antennas of the initiator 110 of FIG. 1 or reflector 120 of FIG. 1. FIG. 5B is a plot 510 of an example distance error across a range of averages of determined quality metric (Q3) for an example implementation of an NN data model. The example plots 500, 510 also illustrate an example threshold quality metric 520.

In the example of FIG. 5A, the distribution of error for the plot 500 is relatively small for quality metrics less than the threshold quality metric 520. However, the error distribution of the plot 500 increases as the quality metric increases. For example, quality metrics 530 correspond to substantial underestimations of distances by the MUSIC model.

In the example of FIG. 5B, the distribution of error for the plot 510 is larger for quality metrics less than the threshold quality metric 520 in comparison to the distribution of error of the plot 500. However, the error distribution of the plot 510 is less than the distribution of error of the plot 500 for quality metrics greater than the threshold quality metric 520. For example, the NN model of the plot 510 does not substantially underestimate distances. In some instances, such as performing distance calculations for safety functions, substantial underestimations of distances may produce safety hazards. Advantageously, the NN model of the plot 510 reduces the underestimations of the MUSIC model of the plot 500. Advantageously, adaptively switching between the models of the plots 500, 510 reduces error in distance measurements.

FIG. 6A is a plot 600 of example performances of the data models 410, 420, 430 of FIGS. 4A and 4B and an example adaptive data model 610 under example LOS conditions. In the example of FIGS. 6A and 6B, the adaptive data model 610 represents an absolute error of distances of the adaptive distance calculator circuitry 160 of FIGS. 1 and 2 as a CDF. At the threshold CDR 440, the adaptive data model 610 accurately determines a distance with an error of approximately twenty centimeters. Advantageously, the adaptive data model 610 has a relatively high accuracy in LOS conditions.

FIG. 6B is a plot 620 of example performances of the data models 410, 420, 430 of FIGS. 4A and 4B and the adaptive data model 610 under example NLOS conditions. At the threshold CDR 440, the adaptive data model 610 accurately determines a distance with an error of approximately one-hundred and fifty centimeters. Such an improvement is approximately a forty-seven percent performance increase in NLOS conditions. Advantageously, the adaptive data model 610 has a relatively high accuracy in NLOS conditions.

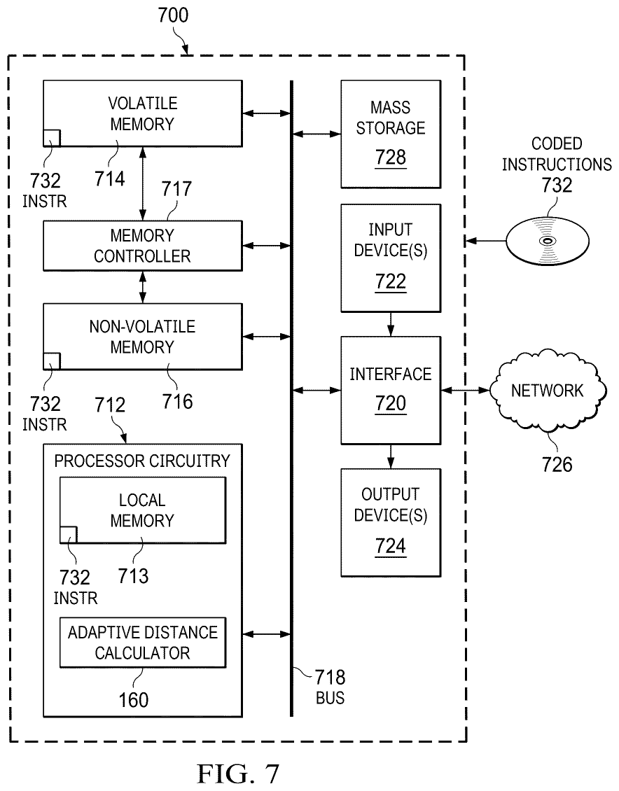

FIG. 7 is a block diagram of an example programmable circuitry platform 700 structured to one or a combination of execute or instantiate one or more of the example machine-readable instructions or the example operations of FIG. 3 to implement the adaptive distance calculator circuitry 160 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, or microcontrollers from any desired family or manufacturer. The programmable circuitry 712 may be implemented by one or more semiconductor based (e.g., silicon based) devices. In this example, the programmable circuitry 712 implements the adaptive distance calculator circuitry 160 of FIGS. 1 and 2.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 716 may be implemented by one or a combination of flash memory or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter one of or a combination of data or commands into the programmable circuitry 712. The input device(s) 722 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 724 are also connected to the interface circuitry 720 of the illustrated example. The output device(s) 724 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 720 of the illustrated example, thus, includes one of or a combination of a graphics driver card, a graphics driver chip, or graphics processor circuitry such as a GPU.

The interface circuitry 720 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store one or more of firmware, software, or data. Examples of such mass storage discs or devices 728 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 732, which may be implemented by the machine-readable instructions of FIG. 3, may be stored in one of or a combination of the mass storage device 728, in the volatile memory 714, in the non-volatile memory 716, or on at least one non-transitory computer readable storage medium such as a CD or DVD which may be removable.

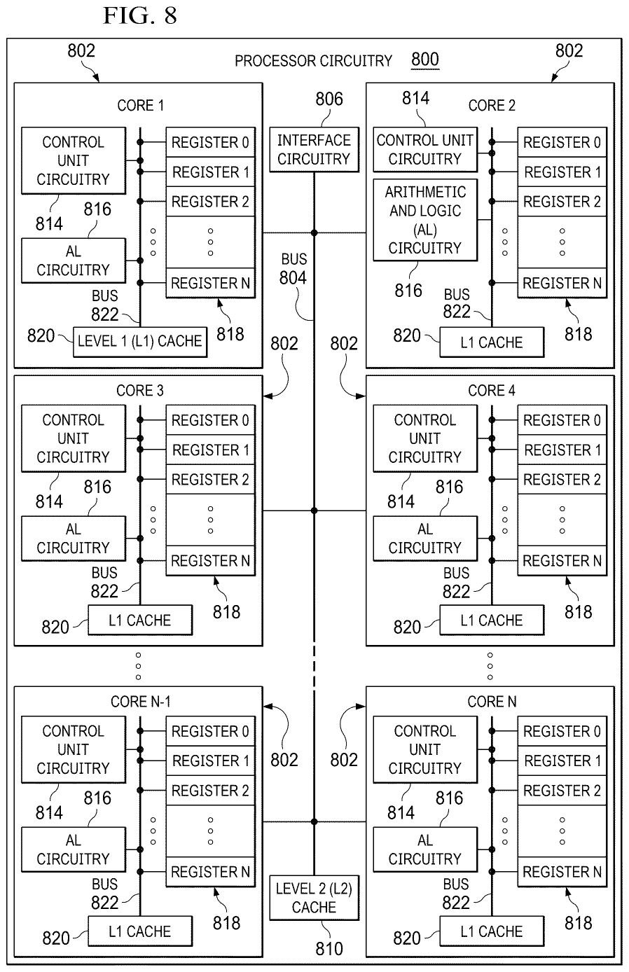

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 3 to effectively instantiate the circuitry of FIG. 2 as logic circuits to perform operations corresponding to those machine-readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions or operations represented by the flowcharts of FIG. 3.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Also or alternatively, the first bus 804 may be implemented by any other type of computing or electrical bus. The cores 802 may receive data, instructions, and signals from one or more external devices by example interface circuitry 806. The cores 802 may output data, instructions, and signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and instructions. Data and instructions may be transferred (e.g., shared) by one of or a combination of writing to or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Usually, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic or logic operations on the data within the corresponding core 802. The AL circuitry 816 of some examples performs integer-based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 or, more generally, the microprocessor 800 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 800 is a semiconductor device fabricated to include many transistors interconnected to implement the structures described above in one or more integrated circuits (ICs) contained in one or more packages.

The microprocessor 800 may include or cooperate with one or more accelerators (e.g., acceleration circuitry, hardware accelerators, etc.). In some examples, accelerators arc implemented by logic circuitry to perform certain tasks more quickly and efficiently than can be done by a general-purpose processor. Examples of accelerators include ASICs and FPGAS such as those described herein. A GPU, DSP, or other programmable device can also be an accelerator. Accelerators may be on-board the microprocessor 800, in the same chip package as the microprocessor 800, or in one or more separate packages from the microprocessor 800.

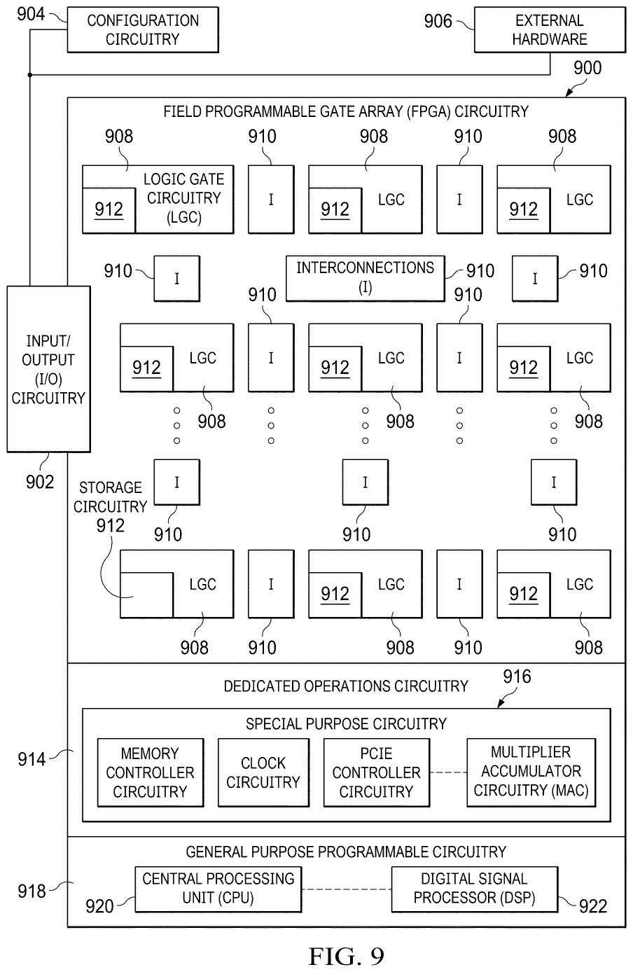

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowchart of FIG. 3 but whose interconnections and logic circuitry are fixed once fabricated), the FPGA circuitry 900 of the example of FIG. 9 includes interconnections and logic circuitry that may be one of or a combination of configured, structured, programmed, and interconnected in different ways after fabrication to instantiate, for example, some or all of the operations/functions corresponding to the machine-readable instructions represented by the flowchart of FIG. 3. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 3. As such, the FPGA circuitry 900 may be at least one of configured or structured to effectively instantiate some or all of the operations/functions corresponding to the machine-readable instructions of the flowchart of FIG. 3 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIG. 3 faster than the general-purpose microprocessor can execute the same.

In the example of FIG. 9, the FPGA circuitry 900 is at least one of configured or structured in response to being programmed (and/or reprogrammed one or more times) based on a binary file. In some examples, the binary file may be one of or both of compiled or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may at least one of access or load the binary file to cause the FPGA circuitry 900 of FIG. 9 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 900 of FIG. 9 to at least one of configure or structure the FPGA circuitry 900 of FIG. 9, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 900 of FIG. 9 may at least one of access or load the binary file to cause the FPGA circuitry 900 of FIG. 9 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 900 of FIG. 9 to at least one of configure or structure the FPGA circuitry 900 of FIG. 9, or portion(s) thereof.

The FPGA circuitry 900 of FIG. 9, includes example input/output (I/O) circuitry 902 to at least one of receive or output data to/from at least one of example configuration circuitry 904 or external hardware 906. For example, the configuration circuitry 904 may be implemented by interface circuitry that may receive a binary file, which may be implemented by one or more of a bit stream, data, or machine-readable instructions, to configure the FPGA circuitry 900, or portion(s) thereof. In some such examples, the configuration circuitry 904 may receive the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIG. 3 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of one of or a combination of the electrical structures or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 or an example DSP 922. Other general purpose programmable circuitry 918 may also or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may also be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowchart of FIG. 3 to perform first operation(s)/function(s), the FPGA circuitry 900 of FIG. 9 may be at least one of configured or structured to perform second operation(s)/function(s) corresponding to a second portion of the machine-readable instructions represented by the flowchart of FIG. 3, and/or an ASIC may be at least one of configured or structured to perform third operation(s)/function(s) corresponding to a third portion of the machine-readable instructions represented by the flowchart of FIG. 3.

Some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same or different times. In some examples, same and/or different portion(s) of the FPGA circuitry 900 of FIG. 9 may be at least one of configured or structured to perform operations/functions corresponding to portion(s) of machine-readable instructions at the same or different times.

In some examples, some or all of the circuitry of FIG. 2 may be instantiated, for example, in one or more threads executing concurrently or in series. For example, the microprocessor 800 of FIG. 8 may execute machine-readable instructions in one or more threads executing concurrently or in series. In some examples, the FPGA circuitry 900 of FIG. 9 may be at least one of configured or structured to carry out operations/functions concurrently or in series. Moreover, in some examples, some or all of the circuitry of FIG. 2 may be implemented within one or more virtual machines or containers executing on the microprocessor 800 of FIG. 8.

In some examples, the programmable circuitry 712 of FIG. 7 may be in one or more packages. For example, at least one of the microprocessor 800 of FIG. 8 or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

While an example manner of implementing the adaptive distance calculator circuitry 160 of FIG. 1 is illustrated in FIG. 2, one or more of the elements, processes, or devices illustrated in FIG. 2 may be combined, divided, re-arranged, omitted, eliminated, or implemented in any other way. Further, the example adaptive distance calculator circuitry 160 of FIG. 2, may be implemented by hardware alone or by hardware in combination with software and firmware. Thus, for example, any of the example adaptive distance calculator circuitry 160, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example adaptive distance calculator circuitry 160 of FIG. 2 may include one or more elements, processes, or devices in addition to, or instead of, those illustrated in FIG. 2, or may include more than one of any or all of the illustrated elements, processes and devices.

A flowchart representative of example machine-readable instructions, which may be executed by programmable circuitry to at least one of implement or instantiate the adaptive distance calculator circuitry 160 of FIG. 2 or representative of example operations which may be performed by programmable circuitry to at least one of implement or instantiate the adaptive distance calculator circuitry 160 of FIG. 2, is shown in FIG. 3. The machine-readable instructions may be one or more executable programs or portion(s) of one or more executable programs for execution by programmable circuitry such as the programmable circuitry 712 shown in the example processor platform 700 described below in connection with FIG. 7 and may be one or more function(s) or portion(s) of functions to be performed by the example programmable circuitry (e.g., an FPGA) described below in connection with FIG. 8 or 9. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 3, many other methods of implementing the example adaptive distance calculator circuitry 160 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, ctc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

What is claimed is:

1. An apparatus comprising:
channel frequency response (CFR) circuitry configured to:
receive communication signals; and
determine magnitudes of the communication signals; and
quality metric circuitry coupled to the CFR circuitry and configured to:
determine a quality metric using the magnitudes of the communication signals;
select one of a first distance estimation model or a second distance estimation model using the quality metric; and
estimate a distance using characteristics of the communication signals and the selected distance estimation model.

2. The apparatus of claim 1,
wherein the quality metric circuitry is configured to select a neural network (NN) model in response to a first value of the quality metric,
wherein the quality metric circuitry is configured to select a multiple signal classification (MUSIC) model in response to a second value of the quality metric, and
wherein the first value of the quality metric indicates more noise in the communication signals than the second value of the quality metric.

3. The apparatus of claim 1, wherein the communication signals include a plurality of received signals, and the CFR circuitry is further configured to determine magnitudes of the plurality of received signals.

4. The apparatus of claim 1, wherein the communication signals include a plurality of reflected signals, and the CFR circuitry is further configured to determine magnitudes of the plurality of reflected signals.

5. The apparatus of claim 1, wherein the quality metric circuitry is further configured to:
determine a maximum magnitude of magnitudes of the communication signals;
determine a minimum magnitude of the magnitudes of the communication signals;
determine an average magnitude of the magnitudes of the communication signals; and
determine the quality metric using the maximum magnitude, the minimum magnitude, and the average magnitude.

6. The apparatus of claim 5, wherein the quality metric circuitry is further configured to:
determine a difference between the maximum magnitude and the minimum magnitude; and
determine the quality metric using a comparison of the difference and the average magnitude.

7. The apparatus of claim 1, wherein the quality metric circuitry is further configured to:
compare the quality metric to a threshold quality metric; and
select the one of the first distance estimation model or the second distance estimation model using the comparison.

8. The apparatus of claim 1, wherein the first distance estimation model includes a neural network (NN) model.

9. The apparatus of claim 1, wherein the second distance estimation model is a multiple signal classification (MUSIC) model.

10. The apparatus of claim 1, wherein the characteristics of the communication signals includes phases of the communication signals.

11. A method comprising:
determining magnitudes of communication signals;
determining a quality metric using the magnitudes of the communication signals;
selecting one of a first distance estimation model or a second distance estimation model using the quality metric; and
estimating a distance using characteristics of the communication signals and the selected distance estimation model.

12. The method of claim 11, further comprising:
determining a maximum magnitude of the magnitudes of the communication signals;
determining a minimum magnitude of the magnitudes of the communication signals;
determining an average magnitude of the magnitudes of the communication signals; and
determining the quality metric based on the maximum magnitude, the minimum magnitude, and the average magnitude.

13. The method of claim 11, further comprising:
comparing the quality metric to a threshold quality metric; and
selecting the one of the first distance estimation model or the second distance estimation model based on the comparison.

14. The method of claim 11, wherein the first distance estimation model is a neural network, and the second distance estimation model is a multiple signal classification (MUSIC) model.

15. At least one non-transitory computer readable storage medium comprising instructions that, when executed, cause programmable circuitry to at least:
determine magnitudes of communication signals;
determine a quality metric using the magnitudes of the communication signals; and
select one of a first distance estimation model or a second distance estimation model using the quality metric to estimate a distance; and
estimate a distance using characteristics of the communication signals and the selected distance estimation model.

16. The at least one non-transitory computer readable storage medium of claim 15, wherein the communication signals includes a plurality of received signals and a plurality of reflected signals, the instructions are to cause the programmable circuitry to:
determine magnitudes of the plurality of received signals; and
determine magnitudes of the plurality of reflected signals.

17. The at least one non-transitory computer readable storage medium of claim 15, wherein the instructions are to cause the programmable circuitry to:
determine a maximum magnitude of the magnitudes of the communication signals;
determine a minimum magnitude of the magnitudes of the communication signals;
determine an average magnitude of the magnitudes of the communication signals; and
determine the quality metric based on the maximum magnitude, the minimum magnitude, and the average magnitude.

18. The at least one non-transitory computer readable storage medium of claim 17, wherein the instructions are to cause the programmable circuitry to:
determine a difference between the maximum magnitude and the minimum magnitude; and
determine the quality metric based on a comparison of the difference and the average magnitude.

19. The at least one non-transitory computer readable storage medium of claim 15, wherein the instructions are to cause the programmable circuitry to:
compare the quality metric to a threshold quality metric; and
select the one of the first distance estimation model or the second distance estimation model based on the comparison.

20. The at least one non-transitory computer readable storage medium of claim 15, wherein the first distance estimation model is a neural network, and the second distance estimation model is a multiple signal classification (MUSIC) model.
